(19) United States
(12) Patent Application Publication
(10) Pub. No.: US 2005/0076745 A1
(43) Pub. Date: Apr. 14, 2005

(54) Method of manufacturing ratchet wrench and the product thereof

(76) Inventor: Ting-Yuan Chen, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/683,290

(22) Filed: Oct. 14, 2003

(51) Int. Cl. B25B 13/46

(52) U.S. Cl. 81/57.39

(57) ABSTRACT

A ratchet wrench is manufactured by using a milling cutter to cut two lateral sides of a ratchet lever located at a front end of the ratchet wrench, so that an open recess having a predetermined size is produced on the ratchet lever; reserving a portion of material at a front end of the ratchet lever during the process of milling; and finishing the reserved material at the front end of the ratchet lever using a numerical control miller to produce a rib vertically extended between upper and lower front edges of the open recess; so that an eccentric shaft, a driving guider, and a ratchet yoke may be positioned in the open recess to complete the ratchet wrench. When the wrench is turned during operation, the rib is able to prevent the ratchet lever from deformation and extend the usable life of the ratchet wrench.

### FIELD OF THE INVENTION

The present invention relates to a method of manufacturing a ratchet wrench, and more particularly to a method for manufacturing a ratchet wrench that is protected against a deformed ratchet lever and therefore has prolonged usable life.

### BACKGROUND OF THE INVENTION

FIGS. 1 and 2 together shows the structure of a conventional electrical ratchet wrench 1. As shown, the ratchet wrench 1 is provided at a front end with a ratchet lever 11, on which a horizontal receiving recess 111 is provided. A needle bearing 12 is put into the receiving recess 111 via a rear opening thereof, and an eccentric shaft 13, a driving guider 14, and a ratchet yoke 15 are sequentially put into the receiving recess 111 via a front opening thereof with the eccentric shaft 13 rearward extended through the needle bearing 12. FIG. 3 shows the manner of machining and forming the ratchet lever 11. A disk milling cutter 2 is used to cut the ratchet lever 11 from a front end thereof so as to produce the receiving recess 111 between two lateral sides of the ratchet lever 11. That is, the receiving recess 111 so formed has three open sides with upper and lower walls thereof in the form of two cantilevers. The ratchet lever 11 in this form is easily deformed due to colliding, dropping, or being used over a long time to result in a completely useless ratchet wrench 1.

### SUMMARY OF THE INVENTION

A primary object of the present invention is to provide a method of manufacturing a ratchet wrench that is protected against an easily deformed ratchet lever and therefore has a prolonged usable life.

The above-mentioned manufacturing method includes the steps of:
using a vertical milling cutter to cut two lateral sides of the ratchet lever, so that a recess having a predetermined size is produced on the ratchet lever;
reserving a portion of material at a front end of the ratchet lever during the process of milling; and
finishing the reserved material at the front end of the ratchet lever using a numerical control miller to produce a rib.

The present invention also provides a ratchet wrench manufactured in the above-mentioned method, a ratchet lever of the wrench includes an open recess extended between two lateral sides of the ratchet lever and a rib integrally formed at a front end of the ratchet lever to vertically extend between upper and lower front edges of the recess as a reinforcement of the ratchet lever, so that the latter is not easily deformed due to colliding, dropping, or being used over a prolonged time, and therefore has extended usable life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional ratchet wrench;

FIG. 2 is an exploded perspective view of a conventional ratchet lever for the ratchet wrench of FIG. 1;

FIG. 3 illustrates the manner of machining and forming the ratchet lever of FIG. 2;

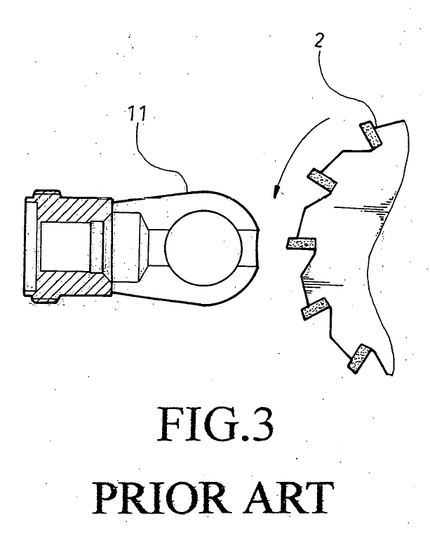

FIG. 4 is a perspective view of a ratchet wrench according to an embodiment of the present invention;

FIG. 5 is an exploded perspective view of a ratchet lever for the ratchet wrench of the present invention; and

FIG. 6 illustrates the manner of machining and forming the ratchet lever of the present invention.

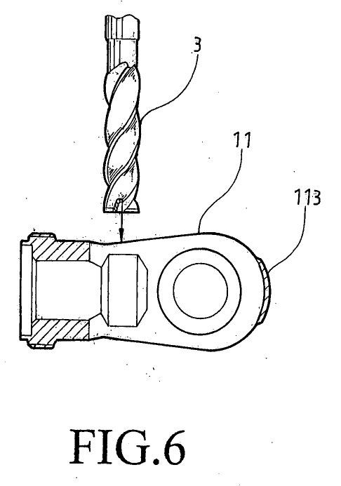

### DETAILED DESCRIPTION OF THE PREFERRED EMBODIMENTS

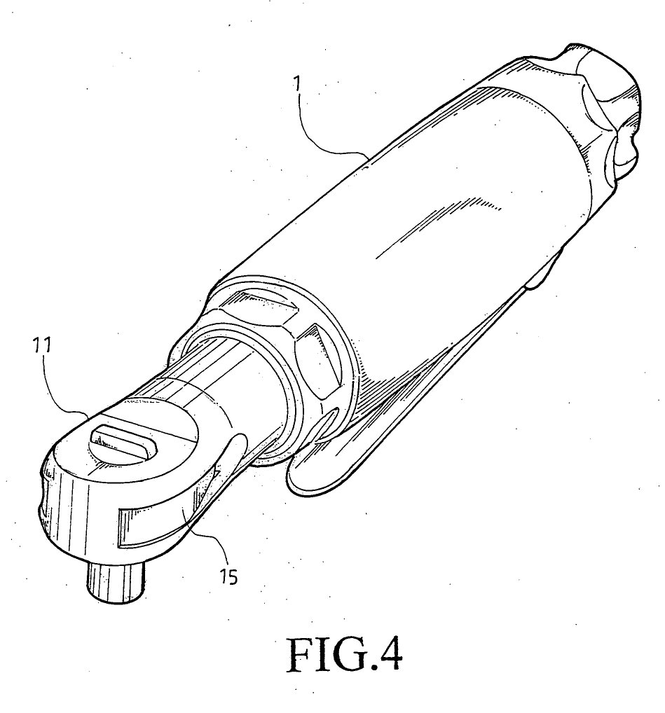

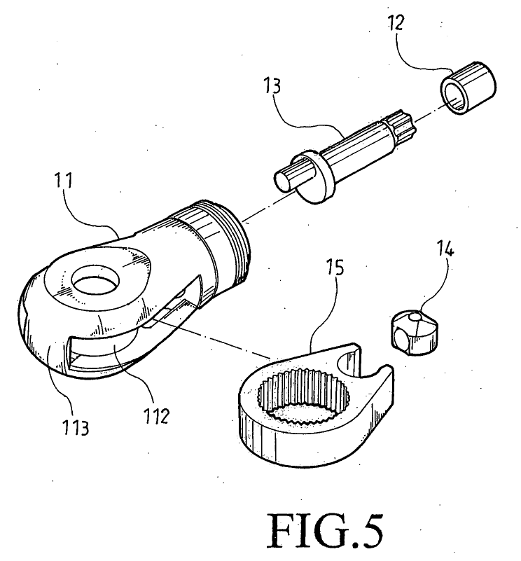

Please refer to FIG. 4 that is an assembled perspective view of a ratchet wrench 1 according to an embodiment of the present invention, and to FIG. 5 that is an exploded perspective view of a ratchet lever 11 provided at a front end of the ratchet wrench 1 of FIG. 4. As shown, the ratchet lever 11 includes an open recess 112 transversely extended between two lateral sides of the ratchet lever 11, and a rib 113 integrally provided at a front end of the ratchet lever 11 to vertically extend between an upper and a lower front edge of the laterally opened recess 112. An eccentric shaft 13 and a needle bearing 12 are sequentially inserted into the ratchet lever 11 via a rear open end thereof, a driving guider 14 is then put into a mouth of a ratchet yoke 15, and the ratchet yoke 15 with the driving guider 14 is put into the open recess 112 from one lateral side of the ratchet lever 11. When the ratchet wrench 1 is turned, the rib 113 effectively protects the ratchet lever 11 against deformation due to colliding, dropping, or using over a prolonged time. The ratchet wrench 1 may therefore have extended usable life.

Please refer to FIG. 5. A method for manufacturing the above-structured ratchet wrench 1 includes the following steps:
1. Using a vertical milling cutter 3 to cut two lateral sides of the ratchet lever 11, so that an open recess having a predetermined size is produced on the ratchet lever 11;
2. Reserving a portion of material at a front end of the ratchet lever 11 during the process of milling; and
3. Finishing the reserved material at the front end of the ratchet lever 11 using a numerical control miller to produce a rib 113.

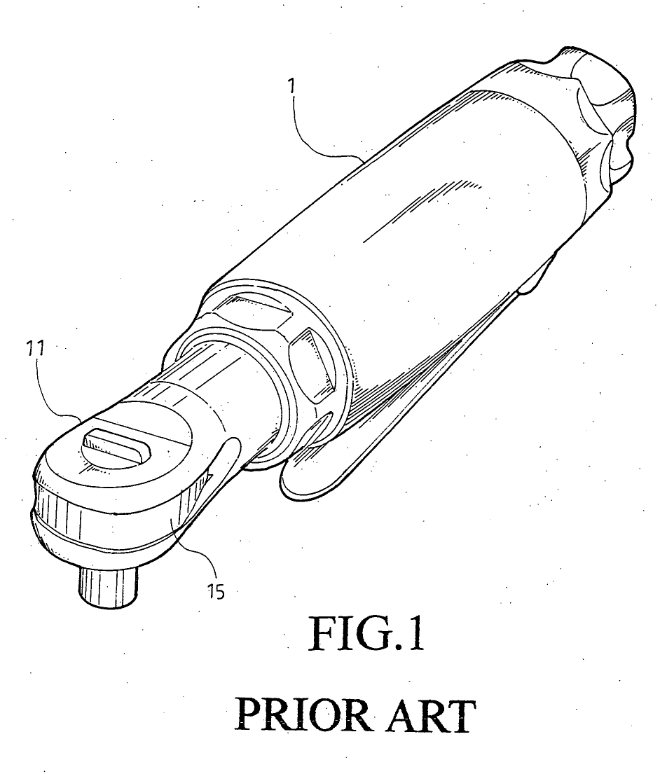

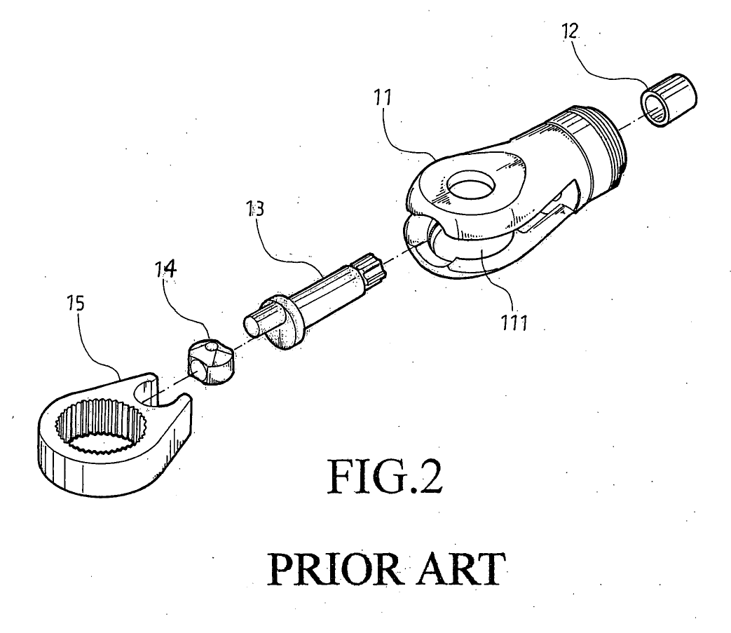

The rib 113 vertically extends at the front end of the ratchet lever 11 to firmly support upper and lower front edges of the open recess in place. Unlike the receiving recess 111 on the conventional ratchet lever 11 having three open sides (see FIGS. 1 and 2), the upper and lower front edges of the open recess 112 on the ratchet lever 11 for the ratchet wrench 1 of the present invention are reinforced with the rib 113 to avoid easy deformation, such as turning outward or inward, due to colliding, dropping, or using over a prolonged time, so that the ratchet wrench 1 may always operate in a normal condition and have an extended usable life.

1. A method of manufacturing a ratchet wrench, comprising the steps of:
using a milling cutter to cut two lateral sides of a ratchet lever located at a front end of said ratchet wrench, so that an open recess having a predetermined size is produced on said ratchet lever;
reserving a portion of material at a front end of said ratchet lever during the process of milling; and
finishing said reserved material at the front end of said ratchet lever using a numerical control miller to produce a rib vertically extended between upper and lower front edges of said recess.

2. A ratchet wrench, comprising a ratchet lever located at a front end of said wrench, said ratchet lever having an open recess extended between two lateral sides of said ratchet lever, and a rib integrally formed at a front end of said ratchet lever to vertically extend between upper and lower front edges of said open recess as a reinforcement of said ratchet lever, so that said ratchet lever with said open recess is protected by said rib against easy deformation.
